(19) United States
(12) Patent Application Publication
(10) Pub. No.: US 2013/0008122 A1
(43) Pub. Date: Jan. 10, 2013

(54) METHOD FOR PRODUCING A TRIM PART PROVIDED WITH A PAINT FILM AND TRIM PART

(75) Inventors: Werner Faltenbacher, Weiden (DE); Ulrich Arlt, Heilsbronn (DE)

(73) Assignee: NBHX TRIM GMBH, Heilsbronn (DE)

(21) Appl. No.: 13/637,050

(22) PCT Filed: Apr. 1, 2011
(86) PCT No.: PCT/EP2011/055113

§ 371 Date: Sep. 25, 2012

(30) Foreign Application Priority Data
Apr. 1, 2010 (DE) 10 2010 013 896.7
Apr. 14, 2010 (DE) 10 2010 014 986.1

(51) Int. Cl. B05D 3/10; B60R 13/02; B05D 3/02

(52) U.S. Cl. 52/716.5; 427/372.2; 427/325

(57) ABSTRACT

The invention relates to a method for producing a vehicle trim part which comprises a substrate and at least one veneer layer disposed on the substrate. The method comprises the steps of extruding a paint layer onto a film and melting the film provided with the paint layer over the substrate and the at least one veneer layer disposed on the substrate.

The invention relates to a vehicle trim part and a method for producing a vehicle trim part which comprises a substrate and at least one veneer layer arranged on the substrate. The present invention also relates to the vehicle trim part comprising a substrate and at least one wood veneer layer arranged on the substrate.

DE 197 06 691 A1 discloses a method for pressing a transparent gloss layer onto the surface of a decorative part. To this end, the separately prefabricated parts of a decorative part and a gloss layer are pressed against each other in a pressing tool, a transparent plastics material connecting film which is free-flowing when heated and is heated accordingly for this purpose being inserted therebetween in the pressing tool. The intermediate film thus applied between the gloss layer and the surface of the decorative part is supposed, inter alia, to allow protected marks and symbols to be placed in the gloss layer in a simple manner. In addition, according to the disclosure a more efficient method is to be provided. The prior art thus discloses the use of a film, but this film is used exclusively to connect a gloss layer part to the decorative surface with positive locking.

The vehicle trim parts known in the prior art comprise on their visible side, above the decoration, which for example is in the form of a wood veneer, a type of gloss layer which forms a transparent outer layer for protecting the decorative layer arranged underneath. Until now, this outer layer has usually been provided by pouring a fluid plastics material over the otherwise finished trim part. However, an outer layer cast in this manner requires significant use of tools during production. In addition, the tools used must meet extraordinary surface requirements in order to ensure a stable and uniform outer layer. In any case, the outer layer provided by this method requires finishing in order to provide a component having a high-grade appearance. When a wood veneer is used as a decorative layer, it is also problematic that the wood outgases further after application of the outer layer, it being possible for bubbles to form under the outer layer which make the entire component unusable.

The object of the present invention is therefore to provide a method by which a vehicle trim part which overcomes the drawbacks of the prior art can be provided more cost-effectively.

The object of the invention is achieved in that a paint layer is extruded onto a film and the film provided with the paint layer is melted on over the substrate and the at least one veneer layer arranged on the substrate. By using the film together with the paint layer applied thereon, the use of expensive casting moulds having finely polished surfaces is avoided and the method according to the invention can be carried out using a press, for example using a membrane press.

The substrate is usually an injection-moulded plastics material part which determines the outer contour of the trim part. Alternatively, however, other substrates such as alternative substrates made of aluminium or the like can be used. The upper face of the substrate forms the visible side of the trim part in the vehicle, the veneer layer extending over the substrate in such a way that usually only the veneer can be seen. “Vehicle” is understood herein to mean any means of transport used on land or water or in the air.

The veneer layer can be glued to the substrate in advance in order to provide a basic component which is merely covered with the film together with the paint layer. The film provided with the paint layer can then be melted onto the basic component such that the multi-layer vehicle trim part according to the invention, comprising a protective outer layer, is provided. Both the film and the paint layer can be transparent, translucent or opaque.

In a preferred configuration, the paint layer is formed by a powder coating which is applied uniformly to a side of the film by means of nozzles and is extruded on by extrusion. It is particularly favourable for the paint layer to be applied by dry coating, thus avoiding non-uniform flow of the paint. Dry coating allows precisely defined application of the desired thickness and distribution of the paint. The powder coating, which is liquid only after the extruding-on process, is united with the film to form a homogeneous unit and can thus be melted uniformly onto the basic component.

By using the film according to the invention, the paint layer can accordingly be thinner and have a thickness of from 0.05 to 2 mm, preferably a thickness of from 0.05 to 0.5 mm. Compared to cast plastics material outer layers used until now in the prior art, paint is thus economised. The film used according to the invention has a thickness of from 0.01 to 0.2 mm, preferably a thickness of from 0.05 to 0.1 mm, and together with the paint layer forms an outer layer which is considerably thinner than those used until now, as a result of which the overall size of the vehicle trim part is reduced. Smaller clearances between the individual trim parts can thus also be achieved in the installed state.

In a preferred configuration, the film provided with the paint layer is melted onto the substrate and the at least one veneer layer in such a way that the film forms the outer face. Even though a homogeneous unit is formed by the extrusion of the paint layer onto the film, it is still preferable for the film to form the outer face, since a plurality of different materials which have particularly high scratch resistance can be used for the film. For example, polypropylene can be used as a film material. In a configuration having an external film arrangement, the paint can compensate irregularities in the veneer surface by penetrating or flowing into depressions which are almost always present in wood veneers. As a result, inclusions can be avoided and a uniform surface ensured.

The film provided with the paint layer is advantageously melted on at 60° C. to 180° C., preferably at 140° C. to 160° C. As a result, a uniform covering over the veneer part is ensured, avoiding any inclusions, and in the case of a polyurethane paint layer an admixed curing agent can also be cracked during the melting-on process, and curing of the paint layer thus ensured. However, a one- or two-component system can also be used.

After a paint layer has been extruded onto the film, said film is laid over the veneer layer and the substrate in such a way that at least the veneer layer is completely covered. The film is preferably cut to size in such a way that all of the veneer layer and parts of the substrate part which extends in the edge region of the veneer layer are covered. After the melting-on process a trim strip is thus provided which is provided with an outer protective layer over the entire outer visible side, and in the installed state only the wood veneer is outwardly visible through this layer.

In one configuration the film is resilient. After application of the paint layer, the film can be stretched over the basic component and fused in the pre-stressed state. A particularly uniform surface layer without inclusions is made possible as a result.

In an advantageous configuration the film, together with the paint layer applied thereto, can be cut to the required measurement prior to the fusion process, the required measurement being predetermined by the size of the veneer layer such that the film extends over the edges thereof. Alternatively, the film can also be laid over the veneer part and the substrate part and the melting process carried out in a predefined, limited region such that after the melting-on process at least all of the veneer part and parts of the substrate are covered by the film together with the paint layer applied thereto. However, in the latter method the film which is melted on in part must be cut off at the melt edges, as a result of which finishing of the edges is usually required.

As indicated above, the method according to the invention relates in particular to the use of wood veneer layers or wood veneer packages which can be used as a veneer layer according to the invention. The method according to the invention is also characterised in that the wood veneer layer is pretreated in such a way that subsequent gas evolution is prevented. To this end the veneer can for example be loaded or inserted in an aqueous or solvent-containing medium.

A particular advantage of the method according to the invention is also that the vehicle trim part can be produced in a single method step, that is to say by carrying out all method steps in one operation. To this end, the basic component, consisting of the substrate and veneer part, and the film provided with a paint layer are arranged one above the other and pressed together in a membrane press. During the pressing process the temperature required for the melting-on process is applied at least to the upper face of the film in order to ensure fusion with the basic component. In this method it is also advantageous that many components can be produced simultaneously in a press having a plurality of receptacles for basic components.

Irrespective of whether the method according to the invention is carried out in one or more steps, the basic component, from a first side, and the film coated with paint, from a second side opposite the first side, are brought together and pressed together. The tool costs are significantly reduced by avoiding the use of casting moulds, and the costs of finishing the surface of the film are minimised. The basic component and the film provided with paint can also be prepared separately and need to be brought together only for the fusion step.

The component protected according to the invention is a vehicle trim part which comprises a substrate and at least one wood veneer layer which is arranged on the substrate and which is covered by an outer layer, the outer layer being formed by a film together with a paint layer extruded thereon. A component formed in this manner is distinguished in that it can be produced cost-effectively. By using as an outer layer a film together with a paint layer extruded thereon, a scratch-resistant surface can be ensured which can be provided easily, cost-effectively and with minimal finishing. The wood veneer layer can be pretreated as described above and glued to the substrate, and in addition an insulating primer can be applied to the wood veneer layer in order to ensure distribution which is as uniform as possible of the film together with the paint layer provided thereon. The vehicle trim part is also distinguished in that the film together with the paint layer extruded thereon is melted on completely over the wood veneer layer and parts of the substrate, such that both the wood veneer layer and parts of the substrate are covered by an outer layer.

All the described features can be combined as desired, provided this is technically possible and not contradictory. Thus, for example, powder coating can be extruded onto the film and the film provided with the powder coating can be cut to size before the melting-on process.

1. A method for producing a vehicle trim part which comprises a substrate and at least one veneer layer arranged on the substrate, the method comprising:
a. extruding a paint layer onto a film,
b. melting the film provided with the paint layer over the substrate and the at least one veneer layer arranged on the substrate.

2. The method according to claim 1, wherein the paint layer is formed by a powder coating.

3. The method according to claim 1, wherein the paint layer is applied by dry coating.

4. The method according to claim 1, wherein the paint layer has a thickness of from 0.05 to 2.0 mm.

5. The method according to claim 1, wherein the film has a thickness of from 0.01 to 0.2 mm.

6. The method according to claim 1, wherein the film provided with the paint layer is melted onto the substrate and the at least one veneer layer in such a way that the film forms the outer face.

7. The method according to claim 1, wherein, after the extruding step, the paint layer and the film form a homogeneous unit.

8. The method according to claim 1, wherein the film provided with the paint layer is melted on at 60° C. to 180° C.

9. The method according to claim 1, wherein the paint layer is made of polyurethane.

10. The method according to claim 1, wherein the film provided with the paint layer completely covers at least the veneer layer.

11. The method according to claim 1, wherein the veneer layer is a wood veneer layer or a wood veneer package which is at least bleached and stained before the melting step.

12. The method according to claim 1, wherein the film provided with the paint layer is cut to size before the melting step in such a way that at least the veneer layer can be completely covered.

13. The method according to claim 1, wherein the film is resilient and is stretched under tension over the veneer layer and the substrate.

14. The method according to claim 1, wherein the substrate and the at least one veneer layer, from a first side, and the film provided with the paint layer, from a second side opposite the first side, are brought together for the melting step.

15. The method according to claim 1, wherein the vehicle trim part can be produced by carrying out all method steps in one operation.

16. The method according to claim 15, wherein the substrate, the at least one veneer layer and the paint layer extruded onto the film are pressed.

17. A vehicle trim part comprising a substrate and at least one wood veneer layer which is arranged on the substrate and which is covered by an outer layer, wherein the outer layer is formed by a film together with a paint layer extruded thereon.

18. The vehicle trim part according to claim 17, wherein an outer face of the outer layer is formed by the film, which completely covers at least the wood veneer layer.

19. The vehicle trim part according to claim 17, wherein the at least one wood veneer layer is glued to the substrate, the film together with a paint layer extruded thereon being melted over the at least one wood veneer layer and also covering at least parts of the substrate.
